(19) United States
(12) Patent Application Publication
(10) Pub. No.: US 2020/0250322 A1
(43) Pub. Date: Aug. 6, 2020

(54) THREE-DIMENSIONAL (3D) MODEL PROTECTION VIA CONSUMABLES

(71) Applicant: Hewlett-Packard Development Company, L.P., Spring, TX (US)

(72) Inventors: Craig Peter Sayers, Palo Alto, CA (US); Helen Balinsky, Bristol (GB)

(73) Assignee: Hewlett-Packard Development Company, L.P., Spring, TX (US)

(21) Appl. No.: 16/612,930

(22) PCT Filed: Oct. 27, 2017
(86) PCT No.: PCT/US2017/058688

§ 371 Date: Nov. 12, 2019

(51) Int. Cl. G06F 21/60; G06F 21/62; B33Y 50/02

(52) U.S. Cl. CPC G06F 21/608; B33Y 50/02; G06F 21/6209

(57) ABSTRACT

A system for protecting a three-dimensional (3D) model defining a 3D object may include a printing consumable, and a data element associated with the printing consumable. The data element defines an assigned association between the printing consumable and a 3D model. A method of protecting a 3D model via consumables may include assigning an association between a printing consumable and a 3D model. The association protects the 3D model based on availability of the printing consumable. The method may include determining whether the printing consumable is installed in a 3D printing device to allow for the forming of a 3D object based on the 3D model, and in response to a determination that the printing consumable is installed in the 3D printing device, permitting the printing of the 3D object using the 3D model and consuming of the printing consumable.

### BACKGROUND

In various manufacturing sectors, individuals and groups may create three-dimensional (3D) models using, for example, computer-aided design (CAD) software. These 3D models may be used to define what a manufactured 3D object is to look like and may be used to produce a specific product. Three-dimensional (3D) printing may be any process that uses additive manufacturing and other techniques to form a 3D object, and 3D printing may utilize the 3D models to form or create the 3D objects. The 3D models, as digital instructions, may be shared through a network to a 3D printing device, and printed to form a 3D object of as high quality or better as those 3D objects developed by other manufacturing methods.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for protecting a three-dimensional (3D) model, according to an example of the principles described herein.

FIG. 2 is a block diagram of a system for protecting a 3D model, according to another example of the principles described herein.

FIG. 3 is a flowchart showing a method of protecting a 3D model via consumables, according to an example of the principles described herein.

FIG. 4 is a flowchart showing a method of protecting a 3D model via consumables, according to another example of the principles described herein.

FIG. 5 is a flowchart showing a method of protecting a 3D model via consumables, according to still another example of the principles described herein.

FIG. 6 is a flowchart showing a method of protecting a 3D printing capability via printing consumables, according to still another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The 3D models, as digital instructions, may be shared through a network to a 3D printing device, and printed using the 3D printing device to form a 3D object. The 3D printing device may be referred to as an additive manufacturing device as it adds materials in successive layers to form a 3D object. In many situations, however, the 3D models may contain proprietary information that may be of great value to an individual or entity. The value may lie in the time and man-power used to design the 3D models, trade secrets included in the design of the 3D model, and the value of printing consumables that may be used in printing the 3D object defined by the 3D model, among others. Not securing these proprietary 3D model can result in competitors legally or illegally manufacturing products that are as high a quality as the original manufacturer or manufacturing products that can compete with the manufacturers products. In other words, a consumer may not be able to differentiate between products that are manufactured using the proprietary 3D model and trade secrets from those that are illegally manufactured. This, in turn, may result in the manufacturer loosing significant market share and business revenue due to having to share a market in which they previously enjoyed the benefits of an exclusive proprietary right to the 3D model.

Further, the transmission of the 3D models without some form of security may result in a recipient of the 3D model such as an operator of a 3D printing device to use the 3D model to print the 3D object defined by the 3D model without having to pay for the use of the 3D model and potentially without permission to use the 3D model in violation of any rights owned by the creator of the 3D model such as copyrights and trade secrets. Use of encryption/decryption key systems may prove to be useful. However, it may often be the case that this information is lost, and transmission of these digital keys may not be user-friendly in implementation.

Further, some businesses have moved to 3D printing to produce products embodying their respective 3D models. In these scenarios, the business may request a 3D manufacturing company, such as service bureau, to produce the products on behalf of the business, but may not wish the 3D manufacturing company to have access to the proprietary 3D models. Although additional payment mechanisms and legally binding agreements such as non-disclosure agreements between the business and the 3D manufacturing company may help to reduce the possibility and liability of loss of any proprietary rights to the 3D models, these types of business and legal mechanisms may be expensive to produce through utilization of legal counsel, and may not ultimately stop willful infringement or violation of such agreements. The examples described herein augment and assist legal mechanisms in preventing unauthorized access to a 3D model, and are more efficient than trying to legally enforce any intellectual property rights in the 3D model after illegally obtained by another individual. Further, some businesses may desire to protect the 3D model against tampering. In these cases, the 3D model may be signed or encrypted or both.

Examples described herein provide a method of protecting a 3D model via consumables may include assigning an association between a printing consumable and a 3D model. The association ensures that the 3D model is not accessed until a decryption key associated with the printing consumable is obtained and used to decrypt the encrypted 3D model. Thus, the protection of the 3D model is based on availability of the printing consumable. The method may include determining whether the printing consumable is installed in a 3D printing device to allow for the forming of a 3D object based on the 3D model, and in response to a determination that a valid and decryption key-containing printing consumable is installed in the 3D printing device, permitting and enabling the printing of the 3D object using the 3D model and consuming of the printing consumable.

The association between a printing consumable and a 3D model may be defined by a decryption key associated with the printing consumable. The method may include encrypting the 3D model with an encryption key. The decryption key is able to decrypt the encrypted 3D model. The method may include permitting the printing of a 3D object based on the 3D model by consuming the printing consumable in response to a determination that the decryption key decrypts the encrypted 3D model. Assigning the association between the printing consumable and the 3D model includes storing the decryption key in a radio frequency identification (RFID) device coupled to the printing consumable. Assigning the association between the printing consumable and the 3D model may include printing the decryption key or some part of the decryption key on the printing consumable. The method may include, in response to a determination that the decryption key is not associated with the printing consumable, restricting the printing of the 3D object using the 3D model and consuming of the printing consumable.

The method may include tracking consumption of the printing consumable, determining if the printing consumable has been refilled, and, in response to a determination that the printing consumable has been refilled, restricting use of the printing consumable to print an object defined by the 3D model.

Examples described herein provide a computer program product for protecting a three-dimensional (3D) model via consumables. The computer program product may include a computer readable storage medium including computer usable program code embodied therewith. The computer usable program code, when executed by a processor, receives, at a 3D printing device, an encrypted 3D model defining a 3D object, decrypts the encrypted 3D model using a decryption key associated with a printing consumable, and prints the 3D object based on the decrypted 3D model and consuming the printing consumable. The association of the decryption key with the printing consumable protects the 3D model based on availability of the printing consumable.

The computer program product may also include computer usable program code to, when executed by the processor, determine whether the printing consumable is installed in the 3D printing device to allow for the printing of the 3D object, determining whether the decryption key is associated with the printing consumable. In response to a determination that the printing consumable is installed in the 3D printing device, the decryption key being associated with the printing consumable, decrypting the encrypted 3D model using the decryption key, and printing the 3D object using the decrypted 3D model and consuming the printing consumable.

The computer program product may also include computer usable program code to, when executed by the processor, determine whether the printing consumable is compatible with the 3D model of the 3D object, and, in response to a determination that the printing consumable is compatible with the 3D model of the 3D object, print the 3D object consuming the printing consumable. In response to a determination that the printing consumable is not compatible with the 3D model of the 3D object, the computer usable program code may restrict printing of the 3D object using the printing consumable.

The computer program product may include computer usable program code to, when executed by the processor, erase the decryption key from the printing consumable in response to a determination that the decryption key has been read into memory of 3D printing device. Further, the computer program product may include computer usable program code to, when executed by the processor, perform signature verification where the signature verification restricts use of the printing consumable. Thus, for example, if the signature verification fails, the 3D printing device may terminate a manufacturing process of the corresponding 3D model.

Examples described herein also provide a system for protecting a three-dimensional (3D) model defining a 3D object may include a printing consumable, and a data element associated with the printing consumable. The data element defines an assigned association between the printing consumable and a 3D model. The data element may include a decryption key embedded within the printing consumable where the decryption key decrypts encrypted data defining the 3D model. The data element may be a computing device embedded in the printing consumable. In this example, the computing device includes a processor and data storage device, and the processor presents a decryption key to a 3D printing device based on data defining the decryption key stored in the data storage device. In another example, the computing device includes both a decryption key and a processor to decrypt the encrypted 3D model using the key. In this case the 3D printing device may provide the encrypted 3D model to the computing device, and the computing device may decrypt the encrypted 3D model in order to make it available to the 3D printing device.

As used in the present specification and in the appended claims, the terms “model” or “3D model” are meant to be understood broadly as any data that defines a 3D object. In one example, the 3D model may be data defining a computer-aided designed object. Further, in one example, the data defining the 3D model may be any data that may be used by a 3D printing device to print an object based on the 3D model.

As used in the present specification and in the appended claims, the term “printing consumable” is meant to be understood broadly as any material used to form an object from a 3D model of the object including, for example, build materials, adhesives, and agents used during printing, as well as other consumables used by finishing stations providing a number of finishing processes such as polishing stations, heating stations, curing stations, or other finishing stations coupled to a 3D printing device. In one example, a number of printing consumables may be integrated into a 3D printing device, or may include a separate, post-printing device or system.

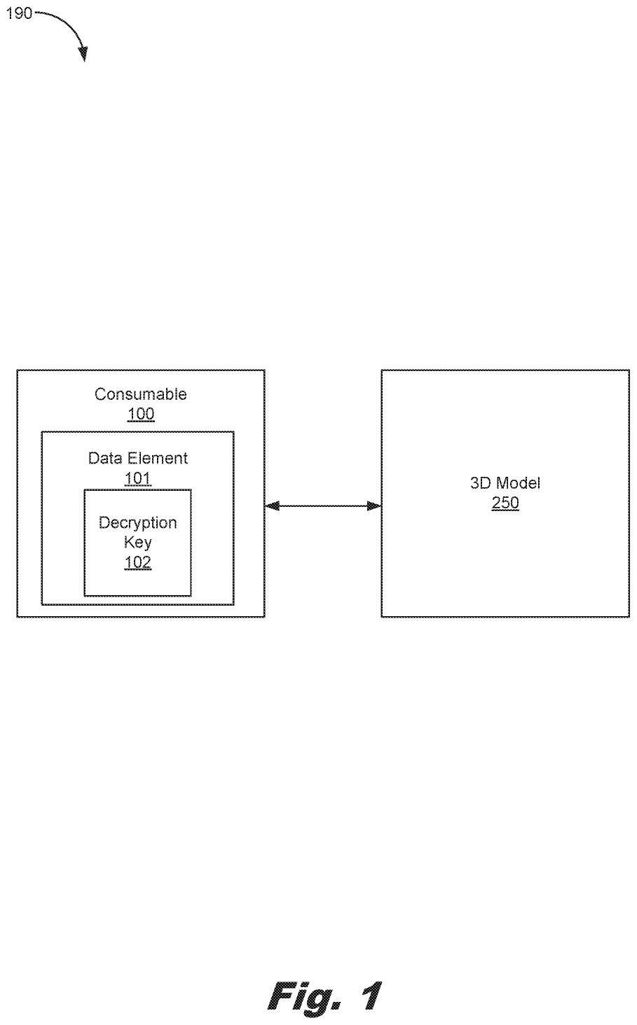

Turning now to the figures, FIG. 1 is a block diagram of a system (190) for protecting a three-dimensional (3D) model (250), according to an example of the principles described herein. The system (190) may include a printing consumable. The printing consumable (100) may be any material or operation used to form an object from a 3D model (250) of the object. For example, in a 3D printing operation, a 3D printing device may use, for example, build materials, and adhesives in forming a 3D object. Further, the 3D printing device may include a number of associated stations such as finishing stations that assist in forming the 3D object. These associated stations may include polishing stations, heating stations, curing stations, or other finishing stations coupled to the 3D printing device. These associated stations may be integrated into the 3D printing device or may be separate devices. Thus, the printing consumable (100) may be any material or agent used to form the 3D object.

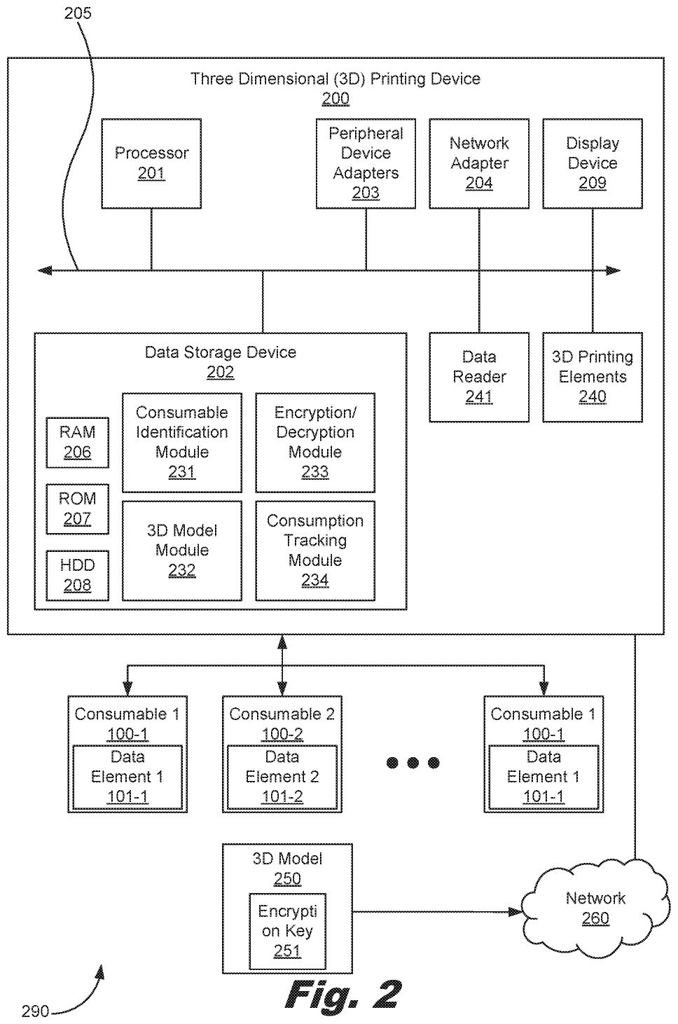

A data element (101) may be associated with the printing consumable (100). The data element (101) defines an assigned association between the printing consumable (100) and the 3D model (250). The 3D model (250) may include any data that defines a 3D object. In one example, the 3D model (250) may be data defining a computer-aided designed object. Further, in one example, the data defining the 3D model (250) may be any data that may be used by a 3D printing device to print an object based on the 3D model (250). The printing consumable (100) and 3D model (250) will now be described in more detail in connection with FIG. 2.

In one example, the data element (101) may also include a number of restrictions used to restrict the use of the 3D model (250). For example, the data element may include restrictions on the model manufacturing such as restricting the use of the consumable to manufacture or print models from company A and not from other entities or sources. In this example, those 3D models (250) that are digitally signed by company A may be printed. Other restrictions may include how many copies may be printed, in which geographical area such as a country's legal jurisdiction, other restriction, or combinations thereof. Existence of the data of the data elements (101) and authenticity may be made a condition for an object based on the 3D model (250) to be produced.

FIG. 2 is a block diagram of a system (290) for protecting a three-dimensional (3D) model, according to another example of the principles described herein. Portions of the system (290) may be implemented in an electronic device. Examples of electronic devices include servers, desktop computers, laptop computers, personal digital assistants (PDAs), mobile devices, smartphones, gaming systems, and tablets, among other electronic devices. For example, a 3D model (250) of the to-be-printed 3D object may be imported through a network (260) to a 3D printing device (200) using such an electronic device. Further, the 3D printing device (200) may include hardware included in electronic devices as described herein.

The system (290) may be utilized in any data processing scenario including, stand-alone hardware, mobile applications, through a computing network, or combinations thereof. Further, the system (290) may be used in a computing network, a public cloud network, a private cloud network, a hybrid cloud network, other forms of networks, or combinations thereof. In one example, the methods provided by the system (290) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (laaS) hosting equipment such as, for example, servers, storage components, network, and components, among others; application program interface (API) as a service (APlaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud, In another example, the methods provided by the system (290) are executed by a local administrator.

To achieve its desired functionality, the 3D printing device (200) of the system (290) may include various hardware components. Among these hardware components may be a number of processors (201), a number of data storage devices (202), a number of peripheral device adapters (203), and a number of network adapters (204). These hardware components may be interconnected through the use of a number of busses and/or network connections. In one example, the processor (201), data storage device (202), peripheral device adapters (203), and network adapter (204) may be communicatively coupled via a bus (205).

The processor (201) may include the hardware architecture to retrieve executable code from the data storage device (202) and execute the executable code. The executable code may, when executed by the processor (201), cause the processor (201) to implement at least the functionality of receiving data representing a 3D model (250) of a to-be-printed object, printing a 3D object based on the 3D model (250), identifying an assigned association between a printing consumable (100) and a 3D model (250), determining whether a printing consumable is installed in the 3D printing device (200), regulating a provisioning of the printing consumable (100) based on a determination as to whether the printing consumable (100) is installed in the 3D printing device (200), provisioning of the printing consumable (100) based on a determination as to whether a decryption key associated with the printing consumable (100) decrypts an encrypted version of the 3D model, provisioning of the printing consumable (100) based on a determination as to whether the printing consumable is an authentic original which has not been refilled or replenished, other functionality described here, and combinations thereof according to the methods of the present specification described herein. In the course of executing code, the processor (201) may receive input from and provide output to a number of the remaining hardware units.

The data storage device (202) may store data such as executable program code that is executed by the processor (201) or other processing device. As will be discussed, the data storage device (202) may specifically store computer code representing a number of applications that the processor (201) executes to implement at least the functionality described herein. The data storage device (202) may include various types of memory modules, including volatile and nonvolatile memory. For example, the data storage device (202) of the present example includes Random Access Memory (RAM) (206), Read Only Memory (ROM) (207), and Hard Disk Drive (HDD) memory (208). Many other types of memory may also be utilized, and the present specification contemplates the use of many varying type(s) of memory in the data storage device (202) as may suit a particular application of the principles described herein, In certain examples, different types of memory in the data storage device (202) may be used for different data storage needs. For example, in certain examples the processor (201) may boot from Read Only Memory (ROM) (207), maintain nonvolatile storage in the Hard Disk Drive (HDD) memory (208), and execute program code stored in Random Access Memory (RAM) (206). The data storage device (202) may include a computer readable medium, a computer readable storage medium, or a non-transitory computer readable medium, among others. For example, the data storage device (202) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (203, 204) in the 3D printing device (200) of the system (290) enable the processor (201) to interface with various other hardware elements, external and internal to the 3D printing device (200). For example, the peripheral device adapters (203) may provide an interface to input/output devices, such as, for example, a display device (209), a mouse, or a keyboard. The peripheral device adapters (203) may also provide access to other external devices such as an external storage device, a number of network devices such as, for example, servers, switches, and routers, client devices, other types of computing devices, and combinations thereof.

The display device (209) may be provided to allow a user of the system (290) to interact with and implement the functionality of the system (290). The peripheral device adapters (203) may also create an interface between the processor (201) and the display device (209) or other media output devices. The network adapter (204) may provide an interface to other computing devices within, for example, a network (260), thereby enabling the transmission of data between the system (290) and other devices located within the network (260). The system (290) may, when executed by the processor (201), display the number of graphical user interfaces (GUIs) on the display device (209) associated with the executable program code representing the number of applications stored on the data storage device (202). The GUIs may include aspects of the executable code including user-interactive selections available to a user for printing a 3D object based on the 3D model (250).

The 3D printing device (200) may further include a number of 3D printing elements (240) used to form a 3D object based on the 3D model (250). The 3D printing elements may include a number of material printheads, moveable stages on which the 3D object is formed, curing systems, and ventilation systems, among other tools and elements used by a 3D printing device to form the 3D object. The 3D printing elements (240) may be integrated into the 3D printing device (200), or may include a separate, post-printing device or system separate from but associated with the 3D printing device (200).

The system (290) further includes a number of modules used in the implementation of the functionality of the system (290). The various modules within the system (290) include executable program code that may be executed separately, In this example, the various modules may be stored as separate computer program products. In another example, the various modules within the system (290) may be combined within a number of computer program products; each computer program product including a number of the modules.

The system (290) may include a consumable identification module (231) to, when executed by the processor (201), identify a printing consumable (100) associated with the 3D printing device (200). The consumable identification module (231) identifies the data elements (101-1, 101-2, 101-n, collectively referred to herein as (101)) associated with the printing consumable (100-1, 100-2, 100-n, collectively referred to herein as (100)).

In one example, the data elements (101) may include a computing device such as a near-field communication (NFC) device from which data may be read. In this example, the NFC device data elements (101) may use radio-frequency identification (RFID) technologies to allow both the supply of power and the communication of data from a passive electronic tag using radio waves, The data read from the NFC device data elements (101) in this example may include data regarding the 3D model (250); data defining at least a portion of the 3D model, an association between a 3D mode (250) and the printing consumable (100), data identifying a relationship between the printing consumable (100) and the 3D model (250), authorization to use the 3D model and/or the printing consumable (100) to print a 3D object defined by the 3D model (250), an amount of the printing consumable (100), an availability of the printing consumable (100), other data that may be used in performing the functions described herein, or combinations thereof. This data may be read from the NFC device data elements (101) using a data reader (241) and the consumable identification module (231) executed by the processor (201) of the 3D printing device (200). In this example, the data reader (241) may be any NFC compliant device as an initiator that employs electromagnetic induction between two loop antennas, one in the data reader (241) and one in the data elements (101) when NFC-enabled devices are within range, and actively generates an RF field that can power the data elements (101) as passive targets in order to provide data exchange. Further, in one example, the data element (101) may be embedded in the printing consumable (100), and may include a processing device and/or a data storage device for printing the 3D model based on data stored in the data storage device.

In another example, the data element (101) may include an identifier marked on the printing consumable (100), In this example, the identifier may be any imageable series of characters placed on the printing consumable (100) or a container of the printing consumable (100). The data reader (241) in this example may be an optical detector or camera that may image the data element (101) and convey the image to the processor for identification using the executed consumable identification module (231). The identifier data element (101) of this example identifies the 3D model (250) that may be sent to and stored in the data storage device (202) of the 3D printing device (200). Further, like the NFC device data elements (101), the identifier data element (101) of this example may include data regarding the 3D model (250); data defining at least a portion of the 3D model, an association between a 3D mode (250) and the printing consumable (100), data identifying a relationship between the printing consumable (100) and the 3D model (250), authorization to use the 3D model and/or the printing consumable (100) to print a 3D object defined by the 3D model (250), an amount of the printing consumable (100), an availability of the printing consumable (100), other data that may be used in performing the functions described herein, or combinations thereof.

In the examples of data elements (101) described herein, the data elements (101) may include a decryption key (FIG. 1, 102) embedded within or associated with the printing consumable (100). The decryption key (102) may be used to decrypt data defining the 3D model (250) that may be encrypted and sent to an operator of the 3D printing device (200). The decryption key (102) of the data elements (101) may be all or a part of any type of public, private, or symmetric key system, with the 3D printing device (200) either having the other complementary portion of the encryption/decryption key system, or being provided the other channels (e.g. the network (260)). The decryption key (102) of the data elements (101) may be used to decrypt information regarding the use of the 3D model (250) and/or decrypt the 3D model itself or some parts of it. In this manner, the use of the 3D model (250) may be secured based on whether the operator of the 3D printer (200) has possession of at least one of the printing consumables (100). This, in turn, maintains the protection of the 3D model (250) as a trade secret or proprietary information as to the manufacturing of a 3D object defined by the 3D model (250). Further, the systems and methods described herein allow for the association of a 3D model (250) with a number of printing consumables (100) while allowing for other printing consumables (100) to not be associated with the 3D printing capability or permissions to use the 3D model (250) in printing the 3D object. For example, a number of the printing consumables (100) may be used to restrict the use of the 3D model (250) by using the encryption/decryption system. Also, a number of printing consumables (100) may be used by the 3D printing device (200) freely without authorization and without being associated with the 3D model (250). Thus, 3D models (250) may be protected through the printing consumables (100) while still allowing other printing consumables not being used to protect 3D models (250) to be used or consumed by the 3D printing device (200).

Further, in one example, a plurality of printing consumables (100) may be associated with the 3D model (250) and each printing consumable (100) in this example may each have an associated data element (101) that may be identified and authenticated in order to use the printing consumable (100) in printing the 3D object defined by the 3D model (250). In one example, the plurality of printing consumables (100) may be separately identified and authorized such that each may be used independent of the other. In another example, the printing consumables (100) may be identified and authorized together such that each printing consumable (100) is identified and authorized before any of the printing consumables (100) may be used. For example, an operator of the 3D printing device (200) may receive three different printing consumables (100-1, 100-2, 100-3) with data elements (101-1, 101-2, 101-3) that each include identification unique to each printing consumable (100-1, 100-2, 100-3), respectively. The operator may also receive a memory card, data packet via the network (260) or other data transmission containing data representing the 3D model that has been encrypted or otherwise locked. In this example, the data transmission containing data representing the 3D model may remain encrypted or otherwise locked unless the unique identifications of the specific printing consumables (100-1, 100-2, 100-3) are identified by the 3D printing device (200).

The system (290) may include a 3D model module (232). The 3D model module (232) may, when executed by the processor (201), instruct the 3D printing elements (240) to form the 3D object based on the 3D model (250) and consume the printing consumables (100).

The system (290) may include an encryption/decryption module (233). The encryption/decryption module (233) may, when executed by the processor (201), identify a decryption key (102) associated with at least one printing consumable (100) and determine whether the decryption key (102) decrypts an associated encrypted 3D model. The encryption/decryption module (233) may also be used to facilitate in the decryption of an encrypted 3D model (250) using the decryption key (102) within the data element (101) of the printing consumable (100).

The system (290) may include a consumption tracking module (234). The consumption tracking module (234) may, when executed by the processor (201), track the consumption of a printing consumable (100) by the 3D printing device (200) during a print job. The consumption tracking module (234) may also be used to instruct the 3D printing device (200) to stop printing based on an amount of printing consumable (100) left or based on a limitation set by the data element (101) of the printing consumable (100). The consumption tracking module (234) may also, when executed by the processor (201), authenticate a printing consumable (100) to be authentic and not tampered with. For example, a protection may be applied to the printing consumable (100) to prevent the decryption key stored in the printing consumable (100) from being tampered with. In this example, if this protection is removed or tampered with, the 3D printer may be restricted from stops producing a 3D object based on the 3D model (250).

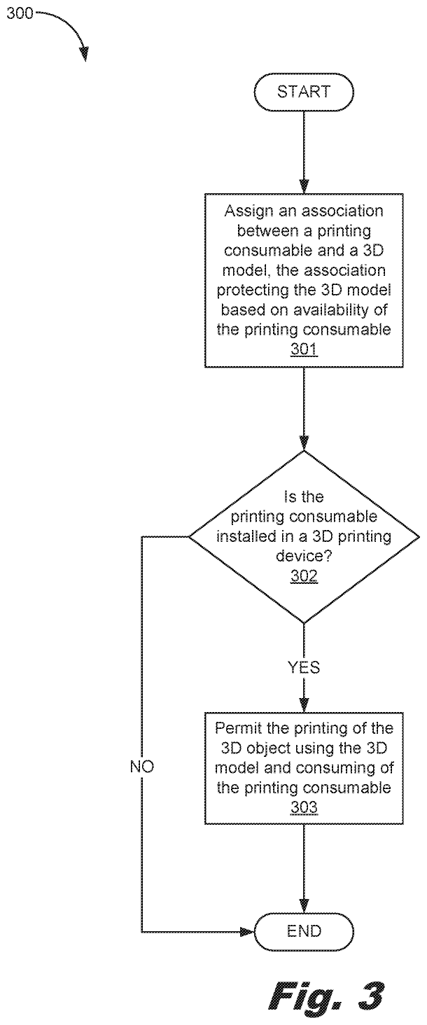

FIG. 3 is a flowchart showing a method (300) of protecting a 3D model (250) via printing consumables (100), according to an example of the principles described herein. The method (300) may begin by assigning (block 301) an association between at least one printing consumable (100) and a 3D model (250). The association (block 301) protects the 3D model (250) based on availability of the at least one printing consumable (100). In other words, the 3D printing device (200) may be restricted from printing the 3D model (250) if the printing consumables (100) associated with the 3D model (250) are not supplied to an operator of the 3D printing device (200), or are not authorized through the use of, for example, an encryption/decryption key system.

The 3D printing device (200) may determine (block 302) whether the printing consumable (100) is installed in the 3D printing device (200) to allow for the forming of a 3D object based on the 3D model (250). This determination (block 302) may be made by the processor (201) executing the consumable identification module (231). Further, as part of this determination (block 302), the 3D printing device (200) may identify the existence of the printing consumable (100) within or attached to the 3D printing device (200), whether the 3D printing device (200) is authorized to utilize the printing consumable (100) to create the 3D object, whether the 3D model (250) calls for the use of the printing consumable (100), or combinations thereof.

In response to a determination that the printing consumable (100) is installed in the 3D printing device (200) to allow for the forming of a 3D object based on the 3D model (250) (block 302, determination YES), the 3D printing device (200) is permitted (block 303) to print the 3D object using the 3D model (250) and consuming of the printing consumable (100). In doing so, the processor (200) may execute the 3D model module (232) and instruct the 3D printing elements (240) to form the 3D object in addition to the use of the 3D model (250) and consuming of the printing consumable (100). However, in response to a determination that the printing consumable (100) is not installed in the 3D printing device (200) to allow for the forming of a 3D object based on the 3D model (250) (block 302, determination NO), the 3D printing device (200) is restricted from using the 3D model (250) and consuming the printing consumable (100) in forming the 3D object based on the 3D model (250), and the method terminates without printing the 3D object.

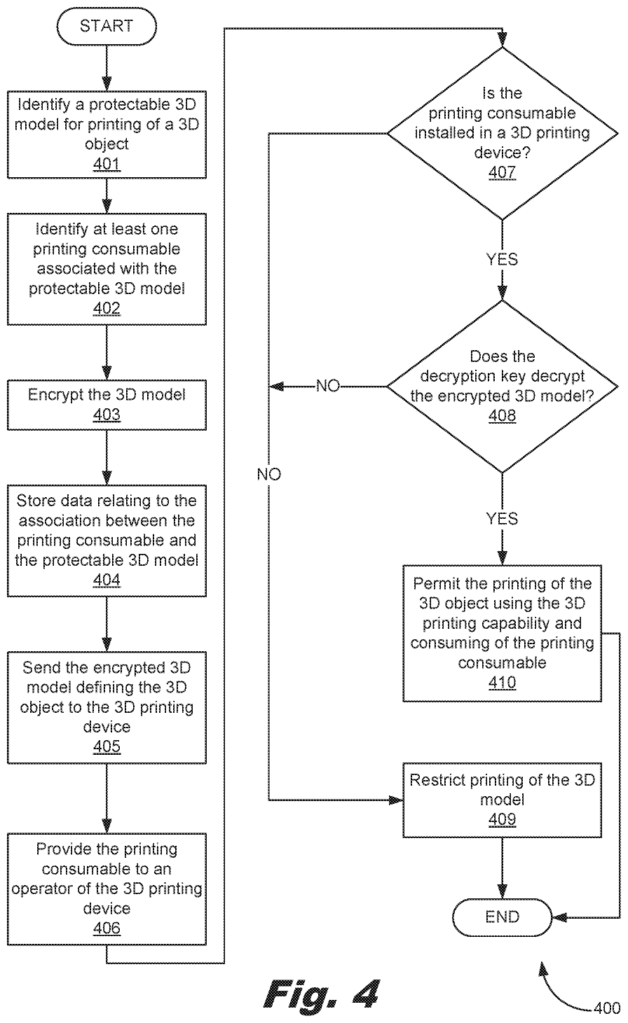

FIG. 4 is a flowchart showing a method (400) of protecting a 3D printing capability via printing consumables (100), according to another example of the principles described herein. The method (400) of FIG. 4 may begin by assigning (block 301) an association between at least one printing consumable (100) and a 3D model (250) as described in connection with FIG. 3. This may include identifying (block 401) the protectable 3D model (250) for printing of the 3D object. As described herein, an entity or individual may desire to protect their proprietary 3D models (250) while still allowing for the manufacturing of their 3D objects using, for example, a 3D printing device (200). In order to do so, the proprietary and protectable 3D models (250) may be identified as such.

In one example, assigning the association between the printing consumable (100) and the 3D model (205) may include storing the data element (101) including the decryption key (102) in a radio frequency identification (RFID) device coupled to the printing consumable (100) as described herein. In another example, wherein assigning the association between the printing consumable (100) and the 3D model (205) may include printing the data element (101) including the decryption key (102) on the printing consumable (100).

The method may also include identifying (block 402) at least one printing consumable (100) associated with the protectable 3D model (250). Any number of printing consumables (100) may be associated with the 3D model (250) based on, for example, the type and intricacies of the 3D model (250), For example, one 3D model (250) may utilize a plurality of printing consumables (100) including, for example, build materials, adhesives, a polishing process in which a polishing device coupled to or associated with the 3D printing device (200) may polish a printed object based on the 3D model (250), and other printing consumables. In this example, the build materials, adhesives, and polishing compounds serve as printing consumables (100). Further, if a finishing chemical is used on connection with a polishing finishing device, the finishing chemical also serves as a printing consumable (100).

The 3D model (250) may be encrypted (block 403). As described herein, a decryption key (102) may be associated with the printing consumable (100). The decryption key (102) and the encrypted 3D model (250) are used to securely transfer the encrypted 3D model (250) to a 3D printing device (200) without an individual being able to use the 3D model (250) to print the 3D object unless a decryption key (102) is also provided. In the examples described herein, the decryption key (102) is provided via the printing consumables (100), and, in this manner, the encrypted 3D model (250) may be decrypted when the consumables (100) including the decryption key (102) are installed in the printing device (200).

In one example, the method (400) may include storing (block 404) data relating to the association between the printing consumable (100) and the protectable 3D model (250). This data may identify the printing consumables (100) used to print a 3D object based on the 3D model (250), and may include instructions regarding the execution of printing instructions defined by the 3D model (250) including, for example, the timing of the use of the printing consumables (100) within the manufacturing or 3D printing process, the duration of use of the printing consumables (100), the frequency of use of the printing consumables (100), other instructions regarding the execution of the 3D model (250), or combinations thereof. The data stored at block 404 may also include data regarding the encryption/decryption key system including, for example, the existence of the decryption key (102) to decrypt data regarding the 3D model (250), the data elements (101) defining an assigned association between the printing consumable (100) and the 3D model (250), or combinations thereof.

The method (400) of FIG. 4 may also include sending (block 405) the encrypted 3D model (250) defining the 3D object to be printed to the 3D printing device (200). In one example, the 3D model (250) may be sent to the 3D printing device (200) using electronic data communications such as email between a computing device of a designer of the 3D model (250) and an operator of the 3D printing device (200). The 3D model (250) defines the instructions used by the 3D printing device (200) to print a 3D object. The processor (200) may execute the 3D model module (232) and instruct the 3D printing elements (240) to form the 3D object based on the 3D model (250). In one example, the 3D model (250) may be sent to the 3D printing device (200) directly as an encrypted file or files to be decrypted by the decryption key (102) within the data elements (101) associated with the printing consumables (100). In another example, the 3D model (250) may be sent to the 3D printing device (200) indirectly as a portion of the data stored with the data elements (101). In still another example, the data elements (101) of the printing consumables (100) may include data that defines a portion of the 3D model (250) less than a total of the 3D model (250) such that both the data sent to the 3D printing device (200) and the data in the data elements (101) are each less than the whole of 3D model (250). This allows for greater security as both the portion of the 3D model (250) sent to the 3D printing device (200) and the portion of the 3D model (250) sent with and stored in the data element (101) of the printing consumable (100) have to exist in order for the whole of the 3D model (250) to be understood and executed.

The printing consumables (100) may be provided (block 406) to the operator of the 3D printing device (200). The method (400) may also include regulating provisioning of the printing consumable (100) based on a determination whether the printing consumable (100) is installed in the 3D printing device (200) to allow for the printing of a 3D object based on the 3D model (250) (block 407) as described herein in connection with block 302 of FIG. 3. This determination (block 407) may be made by the processor (201) executing the consumable identification module (231). Further, as part of this determination (block 407), the 3D printing device (200) may identify the existence of the printing consumable (100) within or attached to the 3D printing device (200), whether the 3D printing device (200) is authorized to utilize the printing consumable (100) to print the 3D object, whether the 3D model (250) calls for the use of the printing consumable (100), or combinations thereof. In response to a determination that the printing consumable (100) is not installed in the 3D printing device (200) to allow for the printing of a 3D object based on the 3D model (250) (block 407, determination NO), the 3D printing device (200) may be restricted (block 409) from using the 3D model (250) and consuming the printing consumable (100) in forming the 3D object based on the 3D model (250), and the method terminates without printing the 3D object.

In response to a determination that the printing consumable (100) is installed in the 3D printing device (200) (block 407, determination YES), the method (400) may determine (block 408) whether the decryption key (102) including within the data element (101) of the printing consumable (100) decrypts the encrypted 3D model (250). In some cases, a number of different printing consumables (100) may be sent to an operator of the 3D printing device (200) and installed in the 3D printing device (200). Less than all of the printing consumables (100) may be used in the printing of the 3D object based on the 3D model (250), and some of the printing consumables (100) may be used to print a separate 3D model (250) that is not associated with the printing consumables (100) of the target 3D model (250). Thus, for the particular 3D model (250), the method may determine (block 408) whether decryption keys (102) included within the data elements (101) of the plurality of printing consumables (100) decrypts the encrypted 3D model (250).

This determination (block 408) may be made by the processor (201) executing the consumable identification module (231). In one example, the consumable identification module (231) may read the decryption key (102) from the data element (101) into the data storage device (202) of the 3D printing device (200) and use the decryption key (102) to decrypt the encrypted 3D model (250). Further, in one example, the consumable identification module (231) may erase the decryption key (102) from the data storage device (202) of the 3D printing device (200) in response to a determination that the decryption key (102) has been read into the data storage device (202) of the 3D printing device (200). By erasing the decryption key (102), the 3D model is further protected from any attempt to obtain the decryption key (102) from the data storage device (202) and use the 3D model (250) without limitation or permission.

In response to a determination that the decryption key (102) is not associated with the printing consumable (100) (block 408, determination NO), the 3D printing device (200) may be restricted (block 409) from using the 3D model (250) and consuming the printing consumable (100) in forming the 3D object based on the 3D model (250), and the method terminates without printing the 3D object or with limited printing of the object such as without the printing consumable (100)-protected feature such as with the use of the finishing devices. However, in response to a determination that the decryption key (102) is associated with the printing consumable (100) (block 408, determination YES), the 3D printing device (200) may be permitted (block 410) to use the 3D model (250) and consume the printing consumable (100) in forming the 3D object based on the 3D model (250), and the method terminates with printing the 3D object.

Further, the printing consumables (100) may be regulated with respect to the operator of the 3D printing device (200). Regulation may take the form of regulating the provisioning of the printing consumable (100), and may include providing or not providing build materials, adhesives, or finishing stations to the operator of the 3D printing device (200).

Further, in one example, a number of limitations may be placed on the operator of the 3D printing device (200) or on the 3D printing device (200) itself. These limitations may include limiting the number of 3D objects that may be printed by the 3D printing device (200) using the 3D model (250) based on the amount of build materials, adhesives, or finishing stations provided to the operator in the printing consumables (100), limiting the number of copies of the 3D object that may be printed, limiting the volume (e.g, in cubic meters) that the 3D printing device (200) may print, limiting the timeframe in which 3D printing device (200) may print using the 3D model (250), limiting the geographical locations at which the 3D printing device (200) may print using the 3D model (250), other limitations, or combinations thereof. These limitations may be stored in the data elements (101) and conveyed to the 3D printing device as rules or parameters that the 3D printing device (200) operates by. By enforcing limitations of the 3D printing device (200) in this manner, the owner of the proprietary and protectable 3D model may ensure that international laws, local laws, and contract provisions are not violated, and may additionally secure his or her rights to the 3D model. In this example, the consumption tracking module (234) may, when executed by the processor (201), track the consumption of a printing consumable (100) by the 3D printing device (200) during a print job, and instruct the 3D printing device (200) to stop printing based on an amount of printing consumable (100) left or based on any other limitation set by the data element (101) of the printing consumable (100). In one example, the exchange and comparison of the encrypted 3D model (250) and the decryption key (102) may utilize a signature verification process where the signature verification process restricts use of the printing consumable (100) based on the limitations and restrictions set. In this example, the digital signature may be any mathematical scheme for demonstrating the authenticity of the 3D model (250). A valid digital signature gives a recipient of the 3D model (250) reason to believe that the 3D model (250) was created by a known sender (authentication), that the sender cannot deny having sent the message (non-repudiation), and that the message was not altered in transit (integrity). In this manner, if the 3D model (250) is not digitally signed by a sender of the 3D model, the use of the 3D model (250), the use of the printing consumable (100), or combinations thereof may be restricted.

In one example, the 3D model (250), the data stored within the data elements (101), or combinations thereof may be digitally signed, In this example, the 3D model (250), the data stored within the data elements (101), or combinations thereof may be digitally signed separately, signed together, or one of the 3D model (250) or the data elements (101) may be digitally signed without the other being signed. An owner of the 3D model (250) or an owner of the data stored within the data elements (101), or an owner of both may digitally sign the 3D model (250) and/or the data stored within the data elements (101) using private signature keys. The owner may be, for example, a corporation that uses its corporate private signature keys to digitally sign the 3D model (250) and/or the data stored within the data elements (101). To validate the signature, the 3D printing device (200) may obtain or have a public key certificate. The public key certificate may be known to the 3D printing device (200) or may be certified by through a public key infrastructure (PKI) signed by a trusted certificate authority.

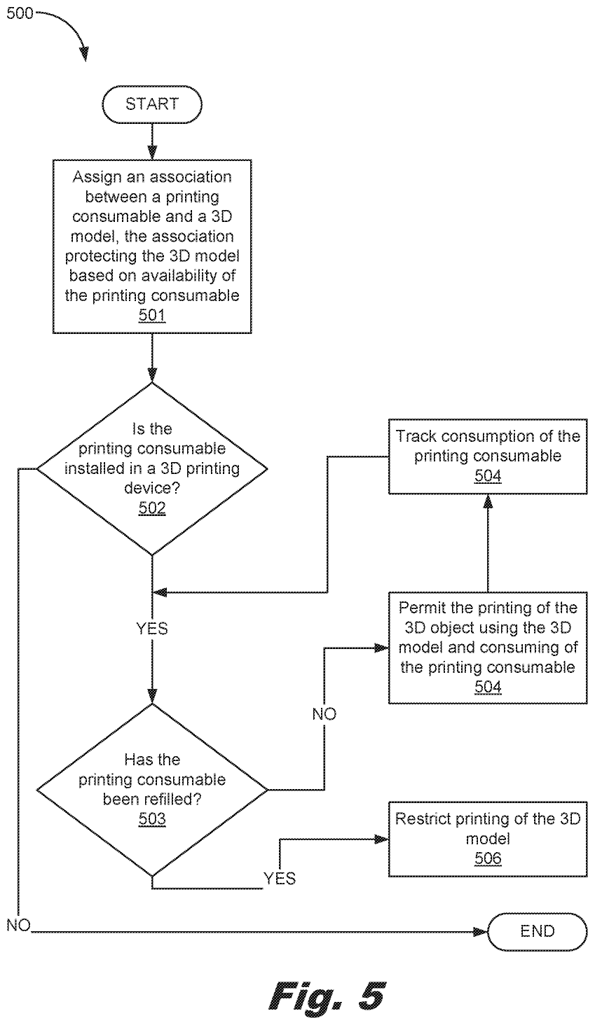

FIG. 5 is a flowchart showing a method (500) of protecting a 3D printing capability via printing consumables (100), according to still another example of the principles described herein. The method of FIG. 5 may include blocks 501 through 502 which are identical to blocks 301 through 302 of FIG. 3, and are described herein. The method of FIG. 5 may include determining (block 503) if the 3D printing consumable has been refilled. In some situations, an operator of the 3D printing device (200) may seek to circumvent any limitations that may be placed on the use of the printing consumables (100) by refilling, for example, any containers of the printing consumables (100) with build materials or adhesives, or agents, by replacing other types of consumables such as finishing compounds or liquids. To prevent refilling of consumables they are placed in tamper evident packaging or other tamper evident features, which are to be opened or broken on the first use. In order to ensure that the limitations set by the owner of the 3D model (250) via the data elements (101) are observed, in response to a determination that the printing consumable (100) has been refilled (block 503, determination YES), the use of the printing consumable (100) to print the 3D object defined by the 3D model (250) may be restricted (block 506). In contrast, in response to a determination that the printing consumable (100) has not been refilled (block 503, determination NO), the method of FIG. 5 may permit the printing of the 3D object using the 3D model (250) and consuming the printing consumable (100). In the method (500) of FIG. 5, the consumption of the printing consumables (100) may be tracked (block 504) using, for example, the consumption tracking module (234) executed by the processor (201) of the 3D printing device (200), and the method (500) may loop back to block 503.

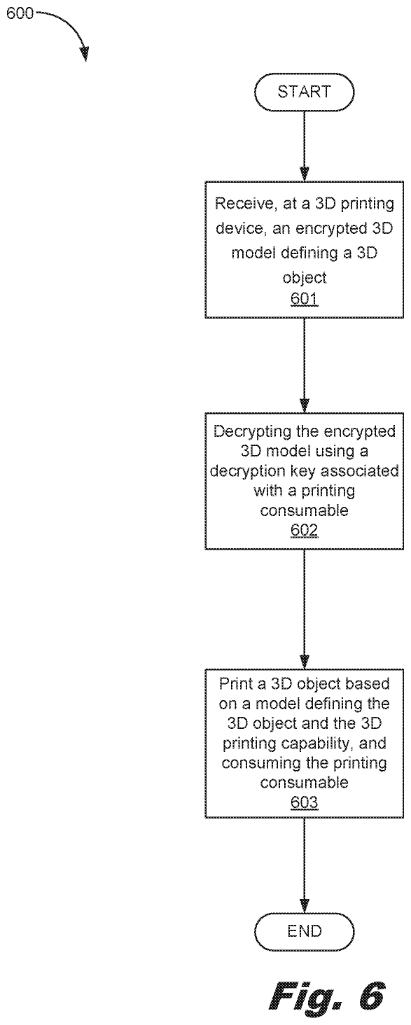

FIG. 6 is a flowchart showing a method (600) of protecting a 3D printing capability via printing consumables (100), according to still another example of the principles described herein. The method (600) of FIG. 6 may include receiving (block 601), at a 3D printing device (200), an encrypted 3D model (250) defining a 3D object. The encrypted 3D model (250) may be decrypted (block 602) using at least one decryption key (102) associated with at least one printing consumable (100). The association of the decryption key (102) with the printing consumable (100) protects the 3D model (250) based on availability of the printing consumable (100) as described herein. The 3D object may be printed (block 603) based on the decrypted 3D model and by consuming the printing consumable (100).

In the examples described herein, it may be determined whether the printing consumable (100) is compatible with the 3D model (250) of the 3D object, and in response to a determination that the printing consumable (100) is compatible with the 3D model (250) of the 3D object, the 3D object may be printed consuming the printing consumable (100). However, in response to a determination that the printing consumable (100) is not compatible with the 3D model of the 3D object, printing of the 3D object using the printing consumable (100) may be restricted. Compatibility of the printing consumable (100) with the 3D model (250) may be based at least partially on if the 3D model calls for use of the printing consumable (100), whether the printing consumable (100) is able to be used as a called for printing consumable (100) even if it is not a specifically called for printing consumable (100), other compatibility parameters, or combinations thereof.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (201) of the 3D printing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

Further, in one example, the 3D model (250) may be incrementally decrypted and use or consumption of the printing consumables (100) may be used based on the portions of the 3D model (250) decrypted at a given time. In this example, the decryption key (102) may define which portions of the 3D model are to be decrypted, and which and how much of the printing consumables (100) are to be used in manufacturing the decrypted portion of the 3D model (250),

The specification and figures describe a system for protecting a three-dimensional (3D) model defining a 3D object may include a printing consumable, and a data element associated with the printing consumable. The data element defines an assigned association between the printing consumable and a 3D model. The specification and figures describe a method of protecting a 3D model via consumables may include assigning an association between a printing consumable and a 3D model. The association protects the 3D model based on availability of the printing consumable. The method may include determining whether the printing consumable is installed in a 3D printing device to allow for the forming of a 3D object based on the 3D model, and in response to a determination that the printing consumable is installed in the 3D printing device, permitting the printing of the 3D object using the 3D model and consuming of the printing consumable.

The systems and methods described herein allow 3D models to be traded by trading physical printing consumables. Further, these systems and methods protect proprietary printing capabilities by using physical objects, but without adding very much overhead since the printing consumables are to be procured and transported to an operator before printing anyway. Still further, the present systems and methods allow key transport without any additional effort since the consumable is transported along with the key, and key management happens seamlessly for the printer operator by allowing the operator to simply insert the consumable for the job, and then print as may be expected. Yet further, the present systems and methods prevent an operator from accidentally or deliberately using a consumable for other customers' print jobs. The decryption key is tied to the consumable and so is in an item which could be owned by the customer, rather than the printer which is owned by the manufacturer. Further, the decryption key can change frequently such as whenever the consumable changes, but there is no additional key-management work for the operator. Also, since the key is inside a consumable, the limitation on how many items can be printed may be physically constrained. Once the consumable is exhausted, the ability to produce parts is removed, and this can happen even if the parts are produced on different printers which are disconnected, and can happen without the buyer needing to know any printer-specific keys.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of protecting a three-dimensional (3D) model via consumables, comprising:
assigning an association between a printing consumable and the 3D model, the association protecting the 3D model based on availability of the printing consumable;
determining whether the associated printing consumable is installed in a 3D printing device to allow for the forming of a 3D object based on the 3D model; and
in response to a determination that the printing consumable is installed in the 3D printing device to allow for the forming of a 3D object based on the 3D model, permitting the manufacturing of the 3D object using the 3D model whilst consuming of the printing consumable.

2. The method of claim 1, wherein the association between a printing consumable and a 3D model is defined by a decryption key associated with the printing consumable, the method comprising encrypting the 3D model, the decryption key being able to decrypt the encrypted 3D model.

3. The method of claim 2, comprising permitting the manufacturing of a 3D object based on the 3D model by consuming the printing consumable in response to a determination that the decryption key decrypts the encrypted 3D model.

4. The method of claim 2, wherein assigning the association between the printing consumable and the 3D model comprises storing the decryption key in a radio frequency identification (RFID) device coupled to the printing consumable.

5. The method of claim 2, wherein assigning the association between the printing consumable and the 3D model comprises printing the decryption key on the printing consumable.

6. The method of claim 2, comprising in response to a determination that the decryption key is not associated with the printing consumable, restricting the printing of the 3D object using the 3D model and consuming of the printing consumable.

7. The method of claim 1, comprising:
tracking consumption of the printing consumable;
determining if the printing consumable has been refilled; and
in response to a determination that the printing consumable has been refilled, restricting use of the printing consumable to manufacture an object defined by the 3D model.

8. A computer program product for protecting a three-dimensional (3D) model via consumables, the computer program product comprising:
a computer readable storage medium comprising computer usable program code embodied therewith, the computer usable program code to, when executed by a processor:
receiving, at a 3D printing device, an encrypted 3D model defining a 3D object,
decrypting the encrypted 3D model using a decryption key associated with a printing consumable; and
manufacture the 3D object based on the decrypted 3D model and consuming the printing consumable,
wherein the association of the decryption key with the printing consumable protects the 3D model based on availability of the printing consumable.

9. The computer program product of claim 8, comprising the computer usable program code to, when executed by the processor:
determining whether the printing consumable is installed in the 3D printing device to allow for the manufacturing of the 3D object;
determining the decryption key is associated with the printing consumable;
validating whether the 3D model is correctly decryptable by the decryption key; and
in response to a determination that the printing consumable is installed in the 3D printing device, and the decryption key is associated with the printing consumable and decrypts the 3D model:
decrypting the encrypted 3D model using the decryption key; and
manufacturing the 3D object using the decrypted 3D model whilst consuming the printing consumable.

10. The computer program product of claim 8, comprising the computer usable program code to, when executed by the processor:
determine whether the printing consumable is compatible with the 3D model of the 3D object;
in response to a determination that the printing consumable is compatible with the 3D model of the 3D object, manufacturing the 3D object consuming the printing consumable; and
in response to a determination that the printing consumable is not compatible with the 3D model of the 3D object, restricting manufacturing of the 3D object using the printing consumable.

11. The computer program product of claim 8, comprising the computer usable program code to, when executed by the processor, erase the decryption key from the printing consumable in response to a determination that the decryption key has been read into memory of 3D printing device.

12. The computer program product of claim 8, comprising the computer usable program code to, when executed by the processor, performing signature verification with regard to the 3D model, the signature verification restricting use of the 3D model, the printing consumable, or combinations thereof.

13. A system for protecting a three-dimensional (30) model defining a 3D object, comprising:
a printing consumable; and
a data element associated with the printing consumable, the data element defining an assigned association between the printing consumable and a 3D model.

14. The system of claim 13, wherein the data element comprises a decryption key embedded within the printing consumable, the decryption key decrypting encrypted data defining the 3D model.

15. The system of claim 13, wherein the data element comprises a computing device embedded in the printing consumable, the computing device comprising a processor and data storage device, the processor presenting a decryption key to a 3D printing device based on data defining the decryption key stored in the data storage device.
